(19) United States
(12) Patent Application Publication
(10) Pub. No.: US 2023/0257849 A1
(43) Pub. Date: Aug. 17, 2023

(54) METHOD FOR SUPPLYING RAW MATERIAL TO A SINTER PLANT

(71) Applicant: PAUL WURTH S.A., Luxembourg (LU)

(72) Inventors: Klaus Peter KINZEL, Sandweiler (LU); Tompson FREITAS, Belo Horizonte - Minas Gerais (BR); José Geraldo ARÁUJO, Belo Horizonte - Minas Gerais (BR); Juan Luis DE FRUTOS SANTAMARIA, Schifflange (LU); Georg STRÜBER, Frisange (LU)

(21) Appl. No.: 17/996,969

(22) PCT Filed: Apr. 21, 2021
(86) PCT No.: PCT/EP2021/060432

§ 371 Date: Oct. 24, 2022

(30) Foreign Application Priority Data
Apr. 24, 2020 (LU) 101759

(51) Int. Cl. C22B 1/245; C22B 1/16; F27D 3/00; C22B 1/24

(52) U.S. Cl. CPC C22B 1/245; C22B 1/16; F27D 3/0033; C22B 1/2413

(57) ABSTRACT

A method for supplying raw material to a sinter plant and facilitating a sinter process with reduced consumption of fossil fuels, provides that a mixed material is used to supply raw material, wherein the mixed material includes particulate iron-containing material and particulate pyrolised biomass in mixed form. The iron-containing material is preferably iron ore and/or the pyrolised biomass is preferably charcoal.

### TECHNICAL FIELD

The disclosure relates to a method for supplying raw material to a sinter plant.

### BACKGROUND

Various iron-containing raw materials can be used for charging a blast furnace, direct reduction and/or electric furnace or the like. One option are iron ore pellets, i.e. spheres of typically 6-16 mm diameter and comprising approx. 63-72% Fe, mainly in the form of Fe₂O₃, and various additional materials to adjust the chemical composition and the metallurgic properties. Also, a binder like Bentonite is included to maintain the cohesion of the pellet. Generally, the production of pellets at the pelletizing plant includes the grinding of the ore, additives and solid fuel, i.e. anthracite coal, pet coke. After mixing the raw materials, the pellet is formed and thermally treated, so called sinter process, e.g. in a kiln. Pellets are a standardized material, chemically stable, that can be transported without significant loss and can be used in the blast furnace without preliminary processing like crushing or the like. Another option is sinter product, which consists of irregular, porous lumps of material produced by sintering fine material (powder 0-5 mm particle size) and breaking up or crushing the sintered bulk material. Since the cohesion of the sinter product is achieved by the sinter process as such, it may not contain a dedicated binder. Sintering of iron-containing fines can only be achieved at elevated temperatures around 1000-1300° C., sometimes also up to 1500° C., wherefore a sintering plant needs considerable amounts of solid fuel, which is mixed with the iron-containing material. A sinter mixture used for the sintering process may e.g. contain iron ore fines, fluxes, solid fuel and recycled fines from the sintering plant itself, a blast furnace or the like. Presently, sinter product is the cheapest iron-containing charge for a blast furnace. It is generally cheaper than pellets since the preparation of the raw material is simpler than for pellets. However, in view of CO₂ emission reduction requirements imposed on the steel industry, a disadvantage is that the sintering method leads to much higher CO₂ emissions than pellet production. These are due to the solid fuel (such as coke breeze and anthracite coal) and gaseous fuel (e.g. steel making gases) needed to support the elevated temperatures for the sintering process.

Thus, the present disclosure facilitates a sinter process with reduced consumption of fossil fuels by a method according to the independent claim.

### SUMMARY

The disclosure provides a method for supplying raw material to a sinter plant. The raw material may also be referred to as feed material or feedstock, i.e. material that is supplied/used in the sinter plant for the sinter process. The type of sinter plant is not limited within the scope of the disclosure. In particular, the sinter plant may be configured as sintering plant or as pelletizing plant. The sinter, i.e. the sinter product or the pellet of the respective sinter plant, is normally intended as ferrous burden material for charging a blast furnace or the like.

According to the inventive method, a mixed material is used to supply the ferrous burden material, wherein the mixed material comprises particulate iron-containing material, generally iron ore, and particulate pyrolised biomass in mixed form. In other words, the mixed material is used to provide at least some of the material that is used for the sinter process. As will be explained below, the mixed material may in some cases not be used as it is, but only after mechanical processing. In other cases, the mixed material can be used for the sinter process in its original form.

In other words, the present disclosure proposes the use of a mixture of particulate iron-containing material and particulate pyrolised biomass as one feed material (feedstock) for a sinter plant (in particular sintering plant or pelletizing plant). The expression ‘mixture of particulate iron-containing material and particulate pyrolised biomass’ means that the two kinds of particulates are not transported and fed individually to the sinter plant, but are mixed. The mixing may occur hundreds or thousands of km away from the site of use, i.e. the sinter plant, and the transport of the particles of iron and biomass as a mixture provides a number of advantages detailed below. In general, the mixture particulate iron-containing material and particulate pyrolised biomass can be a bulk mixture, i.e. the particulates are simply combined/mixed together in a vessel, possibly with some mechanical agitation. The term mixture however also covers the case where the mixture of particulate iron-containing material and particulate pyrolised biomass is processed to form agglomerates. In the former case, the feed material that is supplied to the sinter plant is a bulk/powder material of particulate iron iron-containing material and particulate pyrolised biomass. In the latter case the feed material that is supplied to the sinter plant takes the form of agglomerates (or lumpy products) comprising particulate iron iron-containing material and particulate pyrolised biomass.

The type of sinter plant is not limited within the scope of the disclosure. The term ‘sinter plant’ is used herein to cover a machine or plant that involves material sintering (or frittage), i.e. the forming a solid mass of particulate material by heat without melting it to the point of liquefaction. Sintering plants and pelletizing plants, as known in the ironmaking industry, are two types of sinter plants that involve a ‘sinter process’.

According to the present method, the mixed material comprises pyrolised biomass, wherein the latter is generally charcoal. Typical pyrolising temperatures are between 250 and 550° C., whereby the term ‘pyrolising’ here also covers mild pyrolysis known as torefaction. The biomass may however also be any plant or animal material. For the sake of simplicity, the present document will hereunder generally refer to charcoal only. It is understood that throughout the present document, the term “charcoal” may be substituted with “pyrolised biomass”. Similarly, the term “iron ore” may bereunder be substituted with “iron-containing material”.

Iron ore and charcoal are present in the mixed material in particulate form, i.e. as particles or pieces. The size of the particles is generally not limited within the scope of the disclosure, although certain particle sizes are preferred, as will be discussed below. The iron ore referred to in the present application can generally comprise any iron-containing material, e.g. iron oxides like magnetite (Fe₃O₄) or hematite (Fe₂O₃), usually along with gangue minerals and also waste or residual materials. The charcoal can be any carbon-containing material produced by removing water and volatile constituents from biomass, normally from plant materials like wood, organic waste and/or residual biomass, and/or SRF material (solid recovery fuels). The charcoal particles may have a relatively high carbon content, e.g. above 65 wt.-%, above 70 wt.-% or above 75 wt.-%.

To obtain the mixed material, at least the particulate iron ore and the particulate charcoal are provided and can then be mixed to obtain the mixed material. Mixing may be performed in various ways, like actively by mechanical mixing of the iron ore and charcoal particles (plus optional other components) in a suitable vessel. Suitable devices include a pin mixer, a paddle mixer or a rotary drum mixer. Mixing may also be performed more or less passively, e.g. by pouring the iron ore particles and the charcoal particles into a vessel at the same time, which will also result in at least a certain degree of mixing. Other suitable mixing methods known in the art may be used as well. Optionally, the mixing can be combined with the charging of a transport vessel, like a truck, a container, a train wagon, a ship or the like. This may be a form of passive mixing as indicated above or it may be combined with active mixing immediately before or after charging the particulate material to the transport vessel.

In embodiments, the volumetric proportion of the particulate iron-bearing material in the mixed material may be between 5 and 80 vol %.

The inventive method has various advantages. First, charcoal can be regarded as CO₂ neutral, since it is (normally) generated without the use of fossil fuels. Since at least a part of the fuel needed for the sinter process is provided by the charcoal contained in the mixed material, the effective CO₂ emissions can be reduced significantly. Other advantages pertain to handling and transport of the charcoal-containing mixed material. Since charcoal production requires large amounts of biomass, it is almost impossible to have a charcoal producing facility and the sinter plant at the same geographical location. Therefore, the charcoal needs to be transported. In this context, using mixed material containing iron ore particles and charcoal particles reduces the necessary safety precautions as compared to charcoal as such. Charcoal is a flammable product that normally requires high safety procedures and precautions to be taken. Partially depending on the percentage of charcoal contained in the mixed material, the flammability can be significantly decreased. Of course, this also depends on optional other components of the mixed material. Furthermore, pure charcoal has a very low density (about 0.25 g/cm3) and usually contains a high percentage of fines, which makes its handling complicated due to dust emissions at discharge points. After the charcoal particles have been mixed with iron ore particles and optionally other components, the amount of fines as well as dust emissions can be reduced. This is due to different facts such as e.g. the higher density of the iron ore particles protecting the embedded charcoal particles from being blown away and the iron ore particles being wet, so that in the mixed material, charcoal fines can at least partially be bound by the liquid contained in the iron ore particles.

As mixed material, the charcoal thereby becomes available for long-distance transportation. Such long-distance may be defined as comprising a distance of at least 100 km, preferably at least 500 km, most preferably even several thousands of kilometers. Charcoal can thus e.g. be transported from Brazil or Canada to the United States of America or from Brazil, Canada, United States, Indonesia or Russia to Europe. The long-distance transportation is preferably performed by train or ship.

According to one embodiment, the mixed material is used in the form of compound bodies, wherein each compound body is solid and coherent and comprises particulate iron ore and particulate charcoal. Each of the compound bodies is solid and coherent, i.e. the individual particles are bound together to form the compound body, while the method of binding these particles is not limited in this context. In particular, each compound body can be regarded as an agglomerate or conglomerate comprising these particles. The iron ore particles and the charcoal particles are bound together as parts of the compound body. Insofar, the compound body is not homogenous but is a combination of at least particulate iron ore and particulate charcoal. When the charcoal particles are bound as part of the compound bodies, the amount of fines as well as dust emissions are significantly reduced. Even if fines cannot be completely eliminated, their percentage is normally below 10%, or even below 5%, with the rest being intact compound bodies. As will be explained below, the compound bodies may in some cases not be used as they are, but only after mechanical processing. In this case, the raw material is only in the form of the compound bodies during a certain stage of the supply process, while it may be in another form immediately before it is used in the sinter plant. In other cases, the compound bodies can be used for the sinter process in their original form.

The method may also comprise the production of the compound bodies. In this case, it comprises, prior to supplying the raw material, the following steps. In a first step, particulate iron ore and particulate charcoal are provided. Normally, the iron ore as well as the charcoal needs to be broken, crushed or fragmented and possibly grinded in order to obtain the particulate form. Also, the particles may be sieved in order to obtain a certain range of particle size. Breaking and/or sieving may be part of providing the respective particulate material.

In another step, at least the iron ore and the charcoal are mixed to obtain a mixture. Mixing may be performed in various ways, like actively by mechanical mixing of the iron ore and charcoal particles (plus optional other components) in a suitable vessel. Suitable devices include a pin mixer, a paddle mixer or a rotary drum mixer. Mixing may also be performed more or less passively, e.g. by pouring the iron ore particles and the charcoal particles into a vessel at the same time, which will also result in at least a certain degree of mixing. Other suitable mixing methods known in the art may be used as well.

In another step, the compound bodies are formed from the mixture. Each of the compound bodies may be regarded as an agglomerating or conglomerate containing both iron ore particles and charcoal particles. Depending on the size of the compound bodies, these may e.g. be referred to as blocks, briquettes or pellets or also simple agglomerates in the form of filter cakes or the like. All compound bodies may have the same size and shape or have various sizes and/or shapes. This partially depends on the method of forming the compound bodies. The shape of a single compound body may be irregular or regular, e.g. spherical, cylindrical or cuboid. Mixing and forming may be performed by a single device. The composition of the mixture may be identical to the composition of the mixed material, i.e. the compound bodies. However, its composition may be different, e.g. due to liquid components evaporating during the forming of the compound bodies. Therefore, the terms “mixture” and “mixed material” are not used synonymously in this context.

In some embodiments, a sufficient cohesion of the compound bodies may be achieved e.g. by applying pressure and/or elevated temperature to the mixture of the iron ore and charcoal. In other cases, the achievable degree of cohesion by this approach is not enough. Therefore, the method may further comprise providing at least one binder and the mixture is obtained by mixing at least the iron ore, the charcoal and the at least one binder. Even if the production is not considered as part of the method, each compound body contains at least one binder. The respective binder serves to increase the overall cohesion of the individual compound body. As the mixture is formed, the binder may be present in liquid form and/or solved or suspended in a liquid. When the compound bodies have been formed, liquid components may be evaporated or chemically converted by applying heat to the compound bodies. In some cases, it may be acceptable if a certain amount of liquid introduced by the binder is present in the compound body.

According to one embodiment, at least one organic binder is provided. Examples for suitable organic binders include, but are not limited to, various types of cellulose, dairy waste (like lactose or whey), natural gum (like guar or xanthan gum), wood-related products (like hemicellulose or lignin sulfonate), starches, dextrose, molasses (like sugarcane molasses) and those based on polyacrylamide or polyacrylate structures. Most organic binders can be burnt during the sinter process with little or no solid residues. Also, since they mostly originate from biomass, they can be regarded as CO₂ neutral.

Alternatively or additionally, at least one mineral binder can be provided. Examples of mineral binders include, but are not limited to Bentonite, lime, quicklime (CaO), slaked lime (Ca(OH)₂). Generally, mineral binders (i.e. inorganic binders) do not burn during the sinter process, but remain, possibly in chemically altered form, as part of the sinter or pellet product. Depending on the intended use in the blast furnace, direct reduction and/or electrical furnace or the like, these binder residues may be irrelevant, detrimental or even beneficial. In some cases, mineral binders may be more effective than organic binders.

Preferably, the compound bodies are formed by briquetting. In this context, “briquetting” refers to press agglomerating. A certain amount of the mixture is subjected to pressure, whereby the agglomeration of the particles (and possible other components) is caused or supported. Various types of briquetting may be performed, e.g. extrusion or roll pressing. If extrusion is performed, the primary product is a continuous strand of material which needs to be cut or otherwise separated into compound bodies. Apart from applying pressure, an elevated temperature may be applied, either by heating the mixture or certain parts of the briquetting machine that are in contact with the mixture. Alternatively or additionally, heat may be generated by friction or compression. As mentioned above, the compound bodies resulting from the briquetting process may be referred to as bricks, blocks, briquettes or pellets.

In embodiments, the mixed material is not subjected to agglomeration to form compound bodies, but is used as bulk mixture of particulate iron ore and particulate charcoal, and hence transported and supplied to the sinter plant in that form. In this case also the previously disclosed steps of braking/crushing/fragmenting/grinding, and/or mixing (passive or active) may apply.

As already mentioned above, the location of the charcoal production and the location of the sinter plant are normally far apart. They may be in different countries or even on different continents. Since the charcoal can be transported much easier and safer when it is combined with iron ore particles in the mixed material, especially when it is bound in the form of compound bodies together with the iron ore particles, the mixed material (possibly in the form of compound bodies) should be formed at or near the charcoal plant. This largely avoids any inflammation risk or dust generation problems associated with charcoal transport. According to a typical embodiment of the disclosure, the mixed material (and in particular, the compound bodies) is formed at a first location and the method further comprises transporting the mixed material to a second location, which is at least 100 km from the first location. The second location may be the location of the sinter plant. The distance between the first location and the second location may be even greater, e.g. at least 500 km or several thousand kilometers. In particular, the mixed material may be transported at least partially by train or ship. Under these conditions, cost-effectiveness of the transport largely depends on the total mass transported. Since the charcoal and the iron ore (plus optionally additional components) are transported together, the total mass to be transported for a given quantity of charcoal is significantly increased. In other words, a cost-effective transport (of e.g. 200.000 t) can be realized with a smaller amount of charcoal. By way of example, if a sintering plant has a production rate of 6 Mio. TPY and requires 60 kg of charcoal for 1 t of sinter product, a total amount of 360.000 TPY of charcoal is needed. If the mixed material contains 30% of charcoal, one cost-effective transport can be performed every two months. Such a relatively high transport frequency is beneficial since it reduces the storage capacity needed at the first location as well as the second location. In order to reduce the inflammability of the charcoal the latter will be mixed with the iron bearing material which itself is not inflammable. The proposed volumetric proportion of the iron bearing material in the mix corresponds approximately to the void volume of the charcoal (volume between charcoal particles), which will normally be between approximately 30 and 55 vol %. Higher volumetric ratios of iron ore will, even above the 55 vol % may be preferred to further reduce inflammability. The skilled person may determine the minimum amount based depend on the characteristics of the iron bearing material and the charcoal, on a case by case basis in consideration of specific inflammability and explosion tests.

Despite the abovementioned advantages of a charcoal content that is not too high, the charcoal content should not be too low either, since it is desirable that the charcoal and the iron ore are present in a ratio that is more or less appropriate for the sinter process considering however that the production may use several ore sources and/or charcoal sources. It is therefore desirable that the mixed material comprises at least 1 wt.-% or 10 wt.-% of charcoal, preferably at least 20 wt.-%, more preferably at least 30 wt.-%. Particularly preferred ranges are 1 to 30 wt.-%, 5 to 20 wt.-% and possibly 10 to 20 wt.-%. If the mixed material is in the form of compound bodies, the weight percentage in the mixture from which they are formed may be somewhat lower, e.g. because the mixture contains liquid components that are evaporated in the forming method of the compound bodies.

In order to benefit from the abovementioned advantages connected to a reduction of the charcoal content and in order to provide a sufficient amount of iron ore for the sinter process, it is advantageous if the mixed material comprises at least 20 wt.-% of iron ore, preferably at least 30 wt.-%, more preferably at least 50 wt.-%. Again, if this refers to compound bodies, the weight percentage in the mixture from which these compound bodies are formed may be somewhat lower, e.g. due to evaporation of liquid components.

Forming the coherent compound bodies, which can usually be regarded as agglomerates or conglomerates, is usually easier if the charcoal particles are relatively small. Also, a smaller size of the individual charcoal particle may enhance the effectiveness of the charcoal in the sintering plant process, regardless of whether the mixed material is in the form of compound bodies or not. It is therefore preferred that the particulate charcoal has a D90 sieve size below 10 mm, preferably below 5 mm, more preferably below 3,5 mm. In other words, at least 90% of the charcoal particles have a maximum dimension below 10 mm (or 5 mm or 3.5 mm, respectively).

Various types of iron-containing material, generally iron ore, can be used for the mixed material (e.g. in the compound bodies or agglomerates) in the inventive method. According to one embodiment, the particulate iron-containing material comprises sinter feed particles, which have a sieve size at least mostly between 0.1 mm and 6.3 mm. “Sinter feed” is a term that is commonly used for an iron-containing raw material with the above-mentioned, relatively large/coarse grain size. It is generally produced from iron ores whose chemical properties make them suitable for blast furnace, direct reduction and/or electrical furnace or the like operation without further upgrading. In other words, the iron content in the iron ore is relatively high from the start, i.e. the content of gangue material is low since iron compound(s) and gangue material are relatively well separated. If reference is made to a sieve size of “at least mostly” between 0.1 mm and 6.3 mm, this may refer to at least 80% or at least 90% of the particles having a maximum dimension between 0.1 mm and 6.3 mm.

Alternatively in case of pelletizing plant or additionally in case of sintering plant, the particulate iron ore can comprise iron-containing material with smaller grain size such as concentrate and/or pellet feed particles (hereunder simply referred to as “pellet feed”), which have a sieve size at least mostly below 0.15 mm. Again, this may refer to at least 80% or at least 90% of the particles having a maximum dimension below 0.15 mm. “Pellet feed” is a fine iron ore material that results from upgrading of low-grade iron ores. In such low-grade iron ores, the iron content is low and the iron compounds and the gangue material are not well separated. However, if the iron ore is ground or otherwise separated so that the particle size is reduced, it becomes possible to separate particles with a sufficiently high iron content from those with a lower (or non-existent) iron content. The particles with the high iron content can then be used as pellet feed. As a general trend for sintering plant, the quality of sinter feed is deteriorating since suitable iron ores are not readily available anymore. This can be compensated by at least partially including pellet feed.

As mentioned above, the dimensions of the compound bodies are generally not limited within the scope of the disclosure. Preferably though, the compound bodies have a maximum dimension between 1 mm and 500 mm. if the maximum dimension is below or above this range, production and/or handling of the compound bodies becomes difficult. Small compound bodies, e.g. with maximum dimension is below 15 mm, can be referred to as “pellets”, while larger compound bodies, e.g. with a maximum dimension between 15 mm and 100 mm, could be referred to as “briquettes” and still larger compound bodies could be referred to as “blocks” or “bricks”. As mentioned above, the individual compound body could be spherical, cylindrical, cuboid, flat or even irregular-shaped.

Especially if the maximum dimension of the individual compound body is small, it is conceivable that the compound bodies are used in the sinter plant as they are, i.e. without further processing. According to another embodiment, the compound bodies are fragmented before being used in the sinter plant. Fragmentation may in particular be performed by crushing the compound bodies. The fragmentation process may lead to a partial or complete separation of the charcoal particles from the iron ore particles and possibly also to a fragmentation of individual charcoal and/or iron ore particles. Especially when using the material in a pelletizing plant, the material is usually grinded before entering the sinter process.

In the sintering plant there are principally two methods of adding the charcoal/iron ore mix to the sinter process. The charcoal/iron ore mixture can be added in a sinter mix bedding pile. The sinter mix beddingpile normally consists of horizontal layers of different raw materials. When a sinter mix bedding pile is used, reclaimers normally take away the material in a vertical form perpendicular to the layers. This allows for good mixing of the material also over longer period of times (e.g. one to several weeks). In this case, it is thus easily possible to add the charcoal/iron ore mixture directly. The precautions concerning its segregation into charcoal and iron ore particles during the stacking are thus limited. Nevertheless, depending on the stacking process and if including dosing bins the below described effect of segregation needs also in this case to be considered. The second possibility of introducing the char coal/iron ore mixture in the sintering plant process is in the sintering plant stock house. In this case the mixture will be dosed in the sinter process by special dosing systems such as loss-in-weight feeders, weighing belt conveyors, screw feeders or others. In this case it is important that the charcoal/iron ore mixture is not segregated since its segregation would lead to uncontrolled composition of the sinter mix resulting in problems during the sintering process.

In case of a pelletizing plant when using the charcoal/iron ore mixture, the second possibility does not apply, since the material needs to be grinded before entering the sinter process. Therefore, segregation effects as describe above are not of relevance.

Fragmenting of the compounds is therefore preferably performed shortly before the fragmented material is introduced into the sinter process of a sintering plant, thereby avoiding or reducing to a minimum any problems associated with dust generation or inflammation of charcoal. Preferably the crushing of the compounds may be performed at the outlet of the storage silo just upstream of the dosing device. Although this is unusual, it is also conceivable that the mixed material is fragmented even if it is not in the form of compound bodies. Whereas fragmenting of compounds when introduced in the pelletizing plant all components are to be grinded, separately or together in a grinding unit, before the sinter process.

It is desirable that the mixed material can be used in the sintering method with no or only a minimum of additional material. I.e. the mixed material may represent the majority of the raw feed material to the sinter process. However, in practice, the mixed material may provide at least 10 wt.-% of the iron-containing material and at least 5, preferably at least 10 and more preferable at least 20 wt.-% of the carbon-containing material (fixed carbon) for a sinter process in the sintering and pelletizing plant. In particular in case of the sintering plant, it is preferred that only a reduced amount of pellet feed needs to be added to the raw material, e.g. corresponding to 90 wt.-% or less of the iron-containing material, possibly less than 60 wt.-%. The mixed material may provide at least 10%, preferably at least 40 wt.-%, or more preferable at least 60 wt.-% of the carbon-containing material. It is also preferred that either no anthracite and/or coke breeze need to be added to the raw material or the amount of this additional fuel corresponds to 80 wt.-% or less of the carbon-containing material, e.g. less than 60 wt.-% or less than 40 wt.-%.

In this document, the word sintering means an agglomerate of ores formed by heat treatment, the so-called sinter process. The resulting product can for example be a pellet or sinter.

As indicated before, the term Sinter plant in this document covers an ore agglomeration plant in general involving a sinter process in particular a pelletizing plant and a sintering plant.

This may typically be achieved by submitting the mixture to thermal treatment in a furnace to support the sinter process, typically at 1000 to 1400° C., and typically under an oxidizing atmosphere (O₂ still contained in the gas atmosphere in considerable quantity), similar to conventional pelletizing and sintering processes.

### BRIEF DESCRIPTION OF THE DRAWINGS

Preferred embodiments of the disclosure will now be described, by way of example, with reference to the accompanying drawings, in which:

FIG. 1 is a material flow diagram illustration of a method according to a first embodiment of the present disclosure related to a sintering plant;

FIG. 2 is a process flow chart of the method from FIG. 1;

FIG. 3 is a material flow diagram illustration of a method according to a first embodiment of the present disclosure related to a pelletizing plant;

FIG. 4 is a process flow chart of the method from FIG. 3

FIG. 5 is a material flow diagram illustration of a method according to a second embodiment of the present disclosure related to a sintering plant; and

FIG. 6 is a process flow chart of the method from FIG. 5.

FIG. 7 is a material flow diagram illustration of a method according to a second embodiment of the present disclosure related to a pelletizing plant; and

FIG. 8 is a process flow chart of the method from FIG. 7.

### DETAILED DESCRIPTION OF THE DRAWINGS

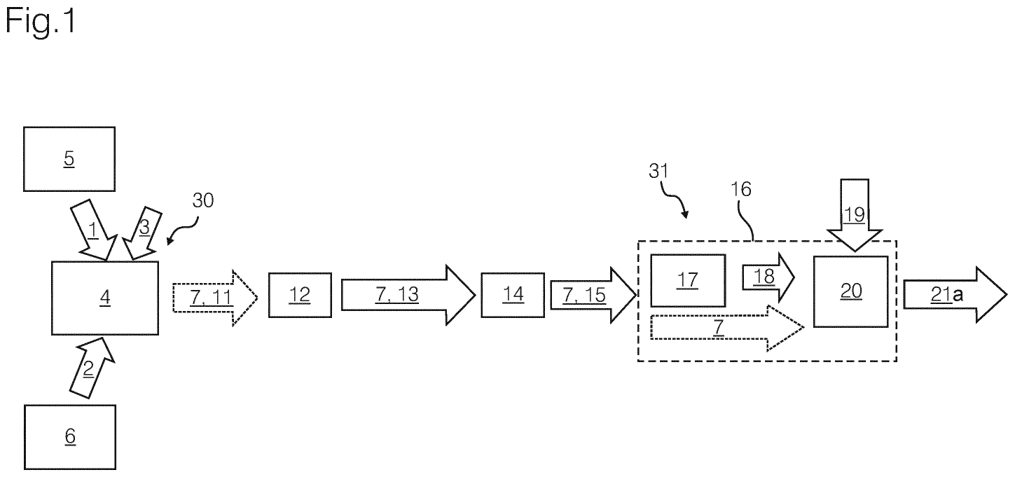

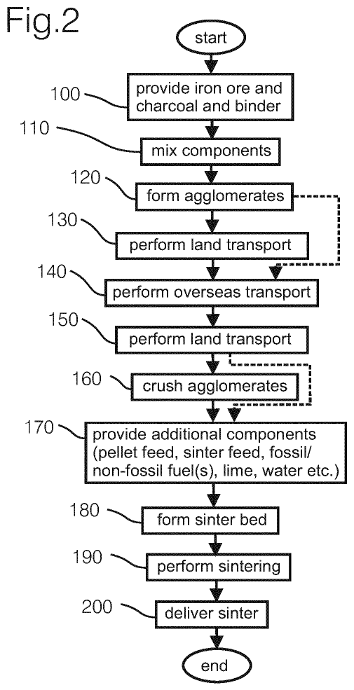

FIG. 1 is a material flow diagram illustrating a first embodiment of the inventive method applied for a sintering plant, while FIG. 2 is a process flow chart of this method. The method will now be explained with reference to both figures. In a first step of the method, at 100, particulate iron-containing material iron ore 1, particulate pyrolised biomass charcoal 2 and a binder 3 are provided. For the sake of simplicity, the present description will use iron ore 1 as iron-containing material 1 and charcoal 2 as pyrolised biomass 2. This is however not to be understood as limiting.

The particulate iron ore 1 is provided from an iron-containing material source such as e.g. an ore mine 5, while the particulate charcoal is provided from a charcoal plant 6. In this embodiment, the particulate iron ore 1 comprises sinter feed, having a particle size between 1 and 6.3 mm, as well as pellet feed, having a particle size below 1.5 mm. Alternatively, it would be possible to use only sinter feed or pellet feed, respectively. The charcoal 2, which may have been produced by slow pyrolysis of plant material, e.g. wood, may have a D90 sieve size below 3.5 mm. The charcoal particles may have a relatively high carbon content, e.g. above 65 wt.-%, above 70 wt.-% or even above 75 wt.-%. The binder 3 can be a mineral binder like bentonite or an organic binder like sugarcane molasses. It could also be a combination of a mineral binder and an organic binder.

In a next step, at 110, the particulate iron ore 1, the particulate charcoal 2 and the binder 3 are mixed to form a mixture. The mixture may also comprise at least one liquid component, which may be part of the binder 3 or which could be added to facilitate the mixing process. From this mixture, agglomerates 7 are formed (at 120) in an agglomerating unit 4, in which mixing may also be carried out. The agglomerating unit 4 may be disposed close to or even at the charcoal plant 6, in order to minimize the transport distance for the charcoal 2. If more convenient, however, it may also be conceivable to place the agglomerating unit 4 close to the iron ore mine or the shipping harbor. Optionally, the formed agglomerates 7 may be subjected to an elevated temperature to cure the binder 3 or to evaporate liquid components. The agglomerates 7 thus formed comprise particulate iron ore 1, particulate charcoal 2 and the binder 3, which may possibly be chemically altered from its initial form by a curing process or the like. The agglomerates 7 may be e.g. cuboid with a maximum dimension of 10 cm.

The agglomerates 7 in their finished state represent solid, coherent compound bodies that are well suited for storage and transport. In particular, since the charcoal 2 is bound in the agglomerates, they necessitate no special safety precautions and the inflammation risk associated with pure charcoal 2 is mostly eliminated. The finished agglomerates 7 are transported (at 130) by a first land transport 11 (e.g. by railway or truck) to a first harbour 12, where they are transferred to a ship for a long-distance overseas transport 13 (at 140). Optionally, the first land transport 11 may be unnecessary, if the briquetting unit is near the first harbour 12. After the ship has reached its destination, a second harbour 14, the agglomerates 7 are unloaded and transferred again. Subsequently, they may be transported by another land transport 15 (at 150) to a steel plant 16 that comprises a crushing unit 17 and a sinter plant 20. As a preparation for the use in the sinter plant 20, the agglomerates 7 are crushed (at 160) in a crushing unit 17, whereby a mixture of smaller particles as crushed material 18 is obtained. In some cases, crushing may be omitted, e.g. if the size of the agglomerates 7 is very small. Most of this crushed material 18 will be pure iron ore particles or pure charcoal particles, normally with at least small amounts of binder, while other particles could comprise at least one charcoal particle bound together with an iron ore particle. There could be a dedicated bin (not shown) in the stock house of the sinter plant 20 where the agglomerates 7 are stored. They can then be dosed, crushed and put on a conveying system (e.g. belt conveyor) feeding the mixing drum or the like of the sinter plant 20. Alternatively to the addition of the mix material in the stock house of the sinter plant, they can also be added further downstream or upstream directly in the sinter mix bedding pile.

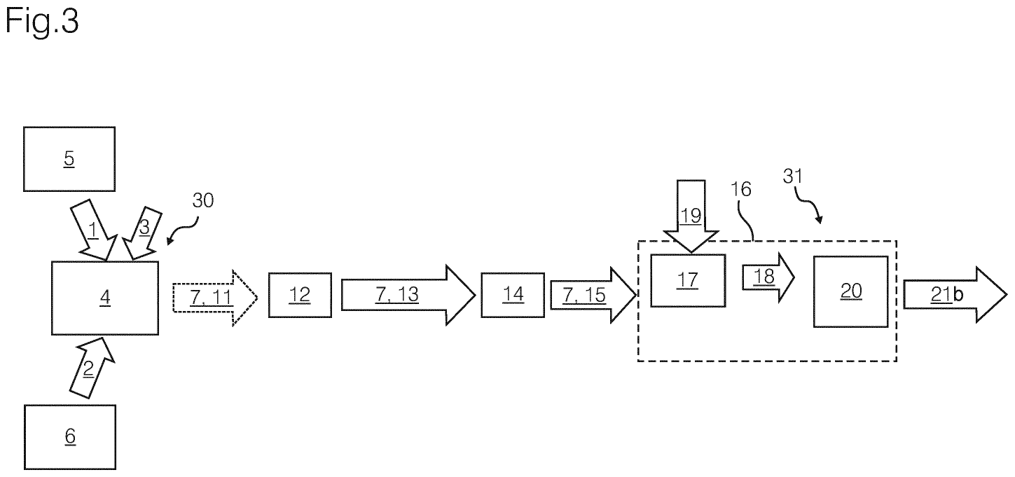

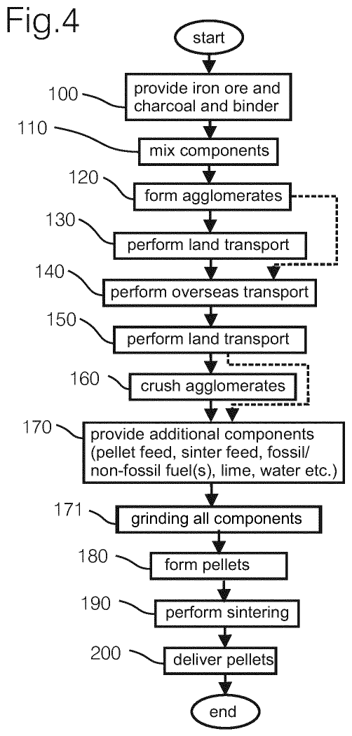

The crushing unit 17 can be disposed relatively close to the sinter plant 20 and special precautions can be taken for the transfer of the crushed material 18 from the crushing unit 17 to the sinter plant 20 to avoid any problems with dust generation or inflammation risk associated with the charcoal particles. Additional components 19 are added at 170, which may comprise e.g. pellet feed and/or sinter feed to supplement the iron ore from the agglomerates 7, fossil fuel like anthracite and/or coke breeze, non-fossil fuel or a combination of both to complete the energy requirement for the sintering process, lime, water or other suitable additives. Then, a sinter bed is formed at 180 and sintering is performed at 190. It is worth noting that the crushed material 18 may be fed to a stock house for mixing with the additional components 19. Alternatively, the crushed material 18 may be added directly to the sinter bed. The charcoal from the agglomerates 7 may represent all of the fixed carbon-containing material for the sinter process. Normally though, it represents only a portion, e.g. between 20 wt.-% and 90 wt.-%, of the carbon-containing material. Either way, the amount of fossil fuel is greatly reduced if not eliminated, wherefore the sinteri process is close to CO₂ neutral. As a result of the sinter process, a sinter product 21a with a defined quality is delivered at 200, which in turn can be used for steelmaking in a blast furnace, direct reduction and/or electric furnace or the like.ln the same context of the first embodiment of the inventive method, FIG. 3 illustrates a material flow diagram, where at the second location 31, the compound mix 7, is introduced into a sinter plant 20, having pellet as a product 21b, instead of sinter product 21a, while FIG. 4 is the corresponding process flow chart of this method. The two inventive methods of the first embodiment are alike, with the main difference that all components for the sintering, the additional material 19 and crushed material 18 or the compound body, agglomerate 7 have to be fragmented further, more specifically grinded 171. All components are then ground at a crushing unit 17, typically to a particle size of D80<0.04 mm, and pellets are formed 180, spheres of typically 6-16 mm diameter, before the sintering can be performed 190. After the sintering is performed 190, the pellet product 21b of a defined quality is delivered at 200, which in turn can be used for steelmaking in a blast furnace, direct reduction and or furnace electric furnace or the like.

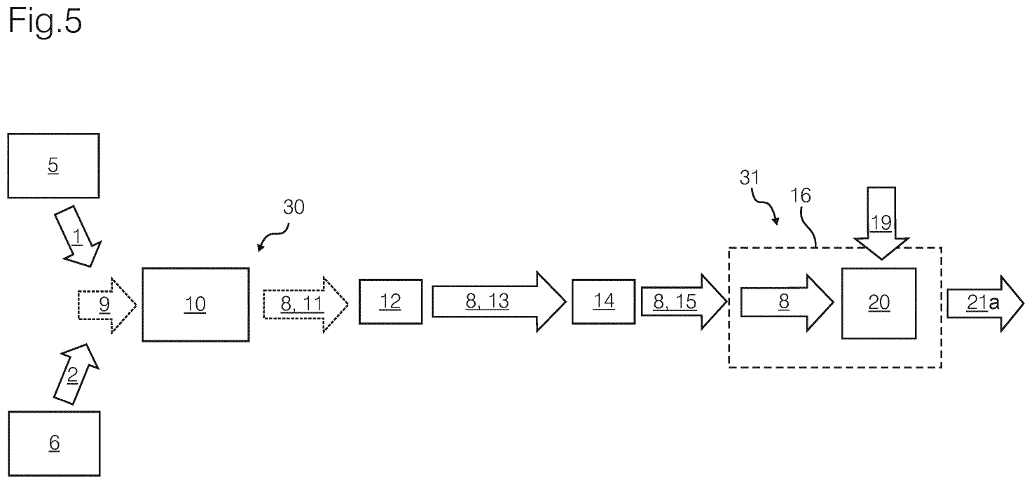

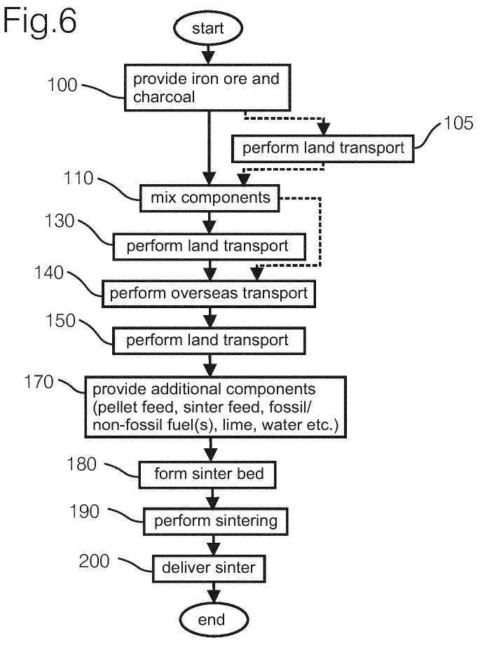

FIG. 5 is a material flow diagram illustrating a second embodiment of the inventive method applied for a sintering plant, while FIG. 6 is a process flow chart of this method. To some degree, this embodiment resembles the first one and therefore will not be described again in full detail. In a first step, at 100, particulate iron ore 1 from an iron ore mine 5 and particulate charcoal 2 from a charcoal plant are provided. Particle sizes and composition can be the same as in the first embodiment.

Optionally, at 105, the particulate iron ore 1 and/or the particulate charcoal 2 may be transported by a (first) land transport 9 to the location 30 of a mixing vessel 10. At 110, the particulate iron ore 1 and the particulate charcoal 2 are mixed in the mixing vessel 10 to obtain a particle mix 8, which does not comprise a binder. Mixing may be performed actively or in a passive way, by simply pouring the particulate iron ore 1 and the particulate charcoal 2 simultaneously into the mixing vessel 10. The particle mix 8 is thus a bulk mixture of the two kinds of particulate material (iron and charcoal), that is transported in this bulk form. This embodiment distinguishes from that of FIG. 1 in that no agglomerates are formed (hence no agglomerating unit 4). The particle mix 8 may however optionally comprise some liquid, introduced with the iron ore 1. Such liquid may help to temporarily bind some charcoal fines and dust, thus reducing the inflammation risk otherwise associated with particulate charcoal 2. The particle mix 8 is thus transported in bulk particulate form (at 130) by a (first or second, respectively) land transport 11 (e.g. by railway or truck) to a first harbour 12, where they are transferred to a ship for a long-distance overseas transport 13 (at 140). It should be noted that the mixing vessel 10 may be part of a railway wagon, a truck or the like used for the land transport 11. Optionally, the land transport 11 may be unnecessary, if the mixing vessel 4 is at the first harbour 12. At a second harbour 14, the particle mix 8 is unloaded and transferred again. Subsequently, it may be transported by another land (or fluvial or other) transport 15 (at 150) to a steel plant 16 that comprises a sinter plant 20, to which the particle mix 8 is provided as raw material/feedstock. No crushing of the particle mix 8 is required and it can be used as it is. The addition of the mix material can be in the stock house (not shown) of the sintering plant or they can be added also further downstream, or even further upstream directly in the sinter mix beding pile.

Additional components 19 are added at 170 as described with respect to the first embodiment, a sinter bed is formed at 180 and sintering is performed at 190. It is again worth noting that the particle mix 8 may be fed to a stock house for mixing with the additional components 19. Alternatively, the particle mix 8 may be added directly to the sinter bed. A sinter product 21a with a defined quality is delivered at 200, which in turn can be used for steelmaking in a blast furnace, direct reduction and/or electric furnace or the like.

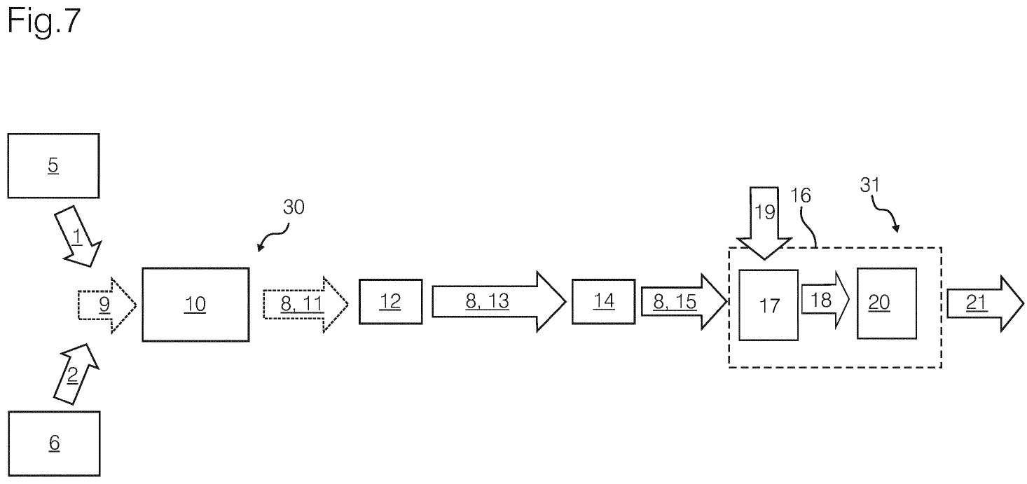

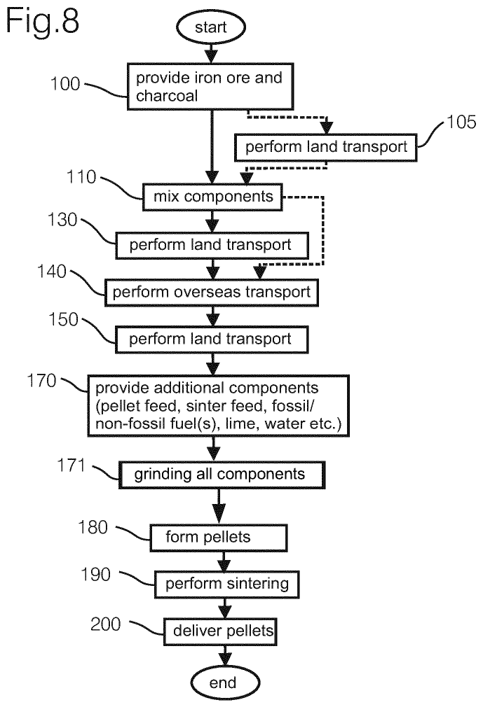

In the same context of the second embodiment of the inventive method, FIG. 7 illustrates a material flow diagram, where at the second location 31, the particle mix 8, is introduced into a sinter plant 20, having pellet as a product 21b, instead of sinter product 21a, while FIG. 8 is the corresponding process flow chart of this method. The two inventive methods of the second embodiment are alike, with the main difference that all components for the sintering, the additional material 19 and particle mix 8 have to be fragmented further, more specifically grinded 171. All components are then ground at a crushing unit 17, typically to a particle size of D80<0.045 mm, and pellets are formed, spheres of typically 6-16 mm diameter, before the sintering can be perform 190. After the sintering is performed 190, the pellet product 21b a defined quality is delivered at 200, which in turn can be used for steelmaking in a blast furnace, direct reduction and or furnace electric furnace or the like.

In both embodiments above, long-distance transportation is performed by ship. However, the present disclosure also covers long-distance transportation by train. In this case, the transport may be carried out in one stage, directly from the first location to the second location.

1. A method for supplying raw material to a sinter plant, wherein a mixed material is used to supply raw material, wherein the mixed material comprises particulate iron-containing material and particulate pyrolised biomass in mixed form.

2. The method according to claim 1, wherein said mixed material is transported over a long distance, said long distance being 100 km, preferably at least 500 km.

3. The method according to claim 1, wherein said mixed material is transported over a long distance by train or ship.

4. The method according to claim 1, wherein the mixed material is used in the form of compound bodies, wherein each compound body is solid and coherent and comprises particulate iron-containing material and pyrolised biomass.

5. The method according to claim 4, further including prior to supplying the raw material:
providing particulate iron-containing material and particulate pyrolised biomass;
mixing at least the iron-containing material and the pyrolised biomass to obtain a mixture; and
forming the compound bodies from the mixture.

6. The method according to claim 5, it further comprising the step of providing at least one binder and the mixture is obtained by mixing at least the iron-containing material, the pyrolised biomass and the at least one binder said binder comprising organic binder or mineral binder.

7. The method according to claim 4, wherein the agglomerates are formed by briquetting.

8. The method according to claim 1, wherein the mixed material is supplied in bulk form to the sinter plant.

9. The method according to claim 1, wherein the mixed material comprises at least 1 wt.-% of pyrolised biomass, and at least 20 wt.-% of iron-containing material.

10. The method according to claim 1, wherein the mixed material comprises 1 wt.-% of pyrolised biomass and at least 30 wt.-% of iron-containing material.

11. The method according to claim 1, wherein the volumetric proportion of the particulate iron-bearing material in the mixed material is between 5 and 80 vol %.

12. The method according to claim 1, wherein the particulate pyrolised biomass has a D90 sieve size below 10 mm.

13. The method according to claim 1, wherein the particulate iron-containing material comprises sinter feed particles, which have a sieve size at least mostly between 0.1 mm and 6.3 mm.

14. The method according to claim 1, wherein the particulate iron-containing material comprises pellet feed particles, which have a sieve size at least mostly below 0.15 mm.

15. The method according to claim 1, wherein the compound bodies have a maximum dimension between 1 mm and 500 mm.

16. The method according to claim 1, wherein the compound bodies are fragmented before being used in the sinter plant.

17. The method according to claim 1, wherein the mixed material provides at least 10 wt.-% of the iron-containing material and at least 5 wt.-% of the carbon-containing material for a sintering process in the sinter plant.

18. The method according to claim 1, wherein said iron-containing material is iron ore and/or said pyrolised biomass is charcoal and/or said compound body is an agglomerate or a conglomerate.

19. A method of operating a sinter plant, wherein iron-containing material and carbon containing material are supplied to said sinter plant, and they are heated in a furnace to support a sinter process in order to form solid iron containing products, wherein the sinter plant is supplied with mixed material according to the method of claim 1.

20. The method according to claim 19, wherein the mixed material is a bulk mixture of particulate iron-containing material and particulate pyrolised biomass.

21. The method according to claim 19, wherein the mixed material comprises agglomerates of particulate iron-containing material and particulate pyrolised biomass.

22. The method according to claim 19, wherein the sinter plant is configured as a sintering plant, the mixed material being optionally crushed and/or combined with additional components, and optionally agglomerated, before being fired in a furnace under an oxidizing atmosphere, and crushing the resulting sinter product.

23. The method according to claim 19, wherein the sinter plant is configured as a pelletizing plant, the method comprising the steps of, at the sinter plant, grinding the mixed material and forming therefrom iron ore green pellets, and charging and firing said green pellets in an indurating furnace under an oxidizing atmosphere to form hardened pellets.

24. The method according to claim 23, wherein the mixed material and additional material including binder material are ground at a crushing unit of the pelletizing plant, and green pellets are formed from the grinded materials.

25. The method according to claim 24, wherein the mixed material and additional material including binder material are ground at a crushing unit of the pelletizing plant to a particle size of D80<0.045 mm, and green pellets are formed from the grinded materials into spheres of about 6 to 16 mm diameter.
